(19) United States
(12) Patent Application Publication
(10) Pub. No.: US 2018/0354748 A1
(43) Pub. Date: Dec. 13, 2018

(54) PASSENGER TRANSPORT INSTALLATION, SERVICING METHOD AND SERVICING CONTROLLER

(71) Applicant: Inventio AG, Hergiswil (CH)

(72) Inventor: Ivo Lustenberger, Buttisholz (CH)

(21) Appl. No.: 15/781,179

(22) PCT Filed: Dec. 16, 2016
(86) PCT No.: PCT/EP2016/081394

§ 371 Date: Jun. 4, 2018

(30) Foreign Application Priority Data
Dec. 17, 2015 (EP) 15200897.5

(51) Int. Cl. B66B 5/00; B66B 1/34

(52) U.S. Cl. CPC B66B 5/0093; B66B 1/343

(57) ABSTRACT

A passenger transport installation, e.g. an elevator or stairway, includes at least one drive motor, a conveying device, sensors and an installation controller. The installation controller is connected to at least one local bus node via a status bus, which bus node can receive status signals from an assigned sensor and transmit the same to the installation controller via the status bus to control the passenger transport installation depending on the status signals received. A servicing controller, as a replacement for at least one of the sensors, is connected to the local bus node that is assigned to the replaced sensor or to a centralized bus node for delivering simulated status signals that correspond to the status signals of the replaced sensor in a state that is selectable by the servicing controller.

### FIELD

The invention relates to a passenger transport installation, in particular an escalator, a moving walkway or an elevator system, and a servicing method for said passenger transport installation and a servicing controller.

### BACKGROUND

Passenger transport installations of the aforementioned type comprise a control device, which processes the operation-related signals of the passenger transport installation and controls the drive motor in consideration of the operation-related signals. Operation-related signals come, for example, from the main switch of the passenger transport installation, from various sensors, pulse generators, encoders and the like and from user interfaces, via which the users can make entries.

The control device comprises at least one computing unit, one main memory and one non-volatile memory having a control program that is required for open- and/or closed-loop control of the passenger transport installation. Furthermore, a control device of this kind may contain interfaces and input modules necessary for servicing the passenger transport installation and for diagnostics, and have a power pack for power supply.

Passenger transport installations further regularly comprise a safety system, which makes it possible to detect unauthorized or critical situations of the passenger transport installation using sensors and optionally to implement suitable measures, such as switching off the installation. Safety circuits are often provided, in which a plurality of safety elements or sensors, such as safety contacts and safety switches, are arranged in a series circuit. The contacts monitor, for example, whether a shaft door or a car door of an elevator installation is open. The elevator car can only be moved when the safety circuit and thus also all of the safety contacts integrated therein are closed. Some of the safety elements are actuated by the doors. Other sensors, such as an overtravel switch, are actuated or triggered by the elevator car. The safety circuit is connected to the drive or the brake unit of an elevator installation in order to interrupt the travel operation if the safety circuit is opened.

However, safety systems comprising safety circuits have various disadvantages. On account of the length of the connections, an undesirably large voltage drop can occur in the safety circuit. The individual safety contacts are relatively susceptible to faults, which is why unnecessary emergency stops can occur. In addition, the safety circuit does not make possible any specific diagnosis, since when the safety circuit is open, it cannot be established which sensor or switch caused said safety circuit to open.

It has therefore been proposed to equip passenger transport installations with a safety bus system rather than a safety circuit, which bus system typically comprises a monitoring unit, a safety bus and one or more bus nodes.

U.S. Pat. No. 7,350,624B2 discloses a bus-based safety system for an elevator installation and a method for inspecting said safety system. The safety system comprises a monitoring unit, at least one bus node, at least one safety element, and a bus, which allows communication between the monitoring unit and the bus node. The bus node comprises first switching means, which apply a first analog signal to the safety element when a target variable is digitally specified by the monitoring unit. Furthermore, the bus node comprises second switching means, which tap an analog signal at the safety element and provide digital feedback information to the monitoring unit via the bus.

U.S. Pat. No. 8,727,095B2 discloses a conveying device comprising at least one endless conveyor for passengers and/or objects which consists of at least one conveying element and comprises a safety system having at least one sensor. By means of the safety system, metal or non-metal conveying elements of an endless conveyor can be detected. The conveying elements to be detected are, for example, hand rail members, steps, pallets or chain links, which form a segmented endless conveyor. The safety system detects every single conveying element and generates operating variables, such as speed and/or acceleration/deceleration, therefrom. If missing or damaged conveying elements are detected, the endless conveyor in question is stopped and/or the error is reported. Conveying devices of this kind also conventionally comprise a bus system having bus nodes, to which at least one safety element or a sensor is assigned.

US 2004/094366 A1 describes an apparatus and a method for remotely servicing an elevator. The apparatus can exchange signals with sensors and an elevator controller of the elevator via a telecommunication network. In order to carry out a stress test, the apparatus may send travel orders to the elevator, in that said apparatus transmits floor or car calls to the elevator.

Elevator installations and escalator installations require regular monitoring and servicing in order to ensure smooth operation and safety. Servicing an installation involves lubricating and cleaning the components, adjustment and readjustment work, and repair work made necessary by wear and tear.

When carrying out servicing work, the installation is often completely switched off. This normally occurs automatically when removing or opening a closing element, a door or a cover, in order to safeguard personnel in danger areas, in which mechanical parts move, for example. However, during repair work in particular, it is often necessary for the elevator installation to be able to be operated fully or in part, such that the operation of the installation can be observed when the covers are opened, for example. In order to prevent undesired shutdown, safety-related signals, in particular switches, which can trigger shutdown of the installation, are often bypassed during servicing. The sensors can be bypassed by means of bridge circuits or software bridges in the monitoring unit. For example, the software can be switched between a first mode of operation, in which normal operation of the installation is provided, and a second mode of operation, in which sensors are bypassed for the purpose of carrying out servicing work.

These simple measures make it possible to keep the apparatus fully or partially operational when servicing work or repairs are being carried out. However, one disadvantage is that neutralization of the safety elements involves a great deal of effort in terms of intervening in the electrical circuit, or is carried out in an inflexible, centralized manner by the central installation controller. The software must be programmed for a servicing mode, in which a particular system configuration is provided for the event of servicing, however the system configuration often does not correspond to the needs of the servicing personnel.

For example, the danger to the servicing personnel is increased during repair or servicing work by potentially unnecessary shutdown of safety mechanisms.

Furthermore, the problem may arise of the inspection of the installation in servicing mode producing a different result than in normal operation. The servicing mode may therefore produce undesired effects.

It should further be noted that, in the event of an installation defect, safety-related functions of the installation could in principle also be affected, which could result in unforeseen system behavior which was not taken into account by the servicing mode.

With regard to carrying out servicing work, it should further be noted that the servicing personnel, who are located at a non-central point of the installation for example, have hardly any opportunity to influence the operation or state of the installation.

With regard to the safety of the installation, it should further be noted that intervention in the safety system should only be carried out by authorized personnel. Unauthorized intervention can hardly be ruled out in installations which, for example, can be switched from a mode of operation to a servicing mode, since, for example, the data for accessing the installation are often still available to operating personnel or servicing personnel even after they leave the company.

### SUMMARY

The present invention therefore addresses the problem of providing an improved passenger transport installation and an improved method for operating and servicing the passenger transport installation. Furthermore, a servicing controller must be provided for said passenger transport installation.

In particular, a passenger transport installation must be provided which makes it possible for servicing work to be carried out in a simplified manner. Moreover, the passenger transport installation should be flexibly adaptable to the needs and requirements of the servicing personnel. Furthermore, it should be possible to carry out test procedures which make possible further inspection of the passenger transport installation, in particular of the safety system. In addition, the servicing personnel should be able to intervene in the passenger transport installation, in particular in the safety system of the passenger transport installation, at the relevant site in a flexible manner. Moreover, the safety of the operating personnel or servicing personnel should be guaranteed as far as possible.

The passenger transport installation, e.g. an elevator or stairway, comprises at least one drive motor, conveying means for conveying passengers, at least one sensor and an installation controller, which is connected to at least one local bus node via a status bus, which bus node can receive status signals from an assigned sensor and transmit same to the installation controller via the status bus, by means of which installation controller the passenger transport installation can be controlled depending on the status signals received.

According to the invention, a servicing controller is provided, which, as a replacement for at least one of the sensors, is connected or can be connected to the local bus node, which is assigned to the replaced sensor, or to a centralized bus node, the servicing controller being provided for delivering simulated status signals that correspond to the status signals of the replaced sensor in a state that is selectable by means of the servicing controller. Said state to which the simulated status signals correspond may for example be fixedly selected by means of corresponding wiring or programming of the servicing controller. It is also possible for said state to be changed at the servicing controller via suitable inputs and therefore to be selectable, and for the servicing controller to then simulate corresponding status signals.

The servicing controller is thus integrated in the passenger transport installation instead of the replaced sensors and can simulate states of the installation and the sensors corresponding thereto preferably in a selective manner. The servicing controller preferably comprises a computing unit, a main memory and a non-volatile memory having a control program. The servicing controller may additionally contain interfaces and input modules or a user interface and may comprise a power pack for power supply.

Preferably, release of a travel operation may be granted for the passenger transport installation only if at least one permissible combination of sensors or a permissible combination of sensors and the servicing controllers is connected to the status bus. In particular, there is a permissible combination of sensors and the servicing controller if the servicing controller replacing the at least one sensor and additional sensors not replaced by the servicing controller are connected to the status bus. In addition, a list of permissible sensor or servicing controller/sensor combinations is stored in the installation controller or in a separate controller. A travel operation is thus only released by means of the installation controller or the separate controller after inspection of the sensors or the sensors and the servicing controller present at the status bus.

The servicing controller can simulate states of a sensor, for example in the embodiment of a switch which monitors the position of the cover on a shaft pit. In this case, the servicing controller can preferably simulate all states of the sensor; in the case of a switch, the open and closed state.

When the cover is actually closed, the open state of the cover and thus of the switch can thus be simulated and it can be checked whether the passenger transport installation reacts according to requirements and, for example, parts of the installation are stopped.

Alternatively, when the cover is actually open, the closed state of the cover and thus of the switch can be simulated and the operation of the passenger transport installation can be checked by the servicing technician inside the shaft pit.

By means of a combination of simulations carried out by the servicing controller, more complex states of the passenger transport installation can also be checked. The servicing controller therefore makes it possible to simulate complex states and to correspondingly inspect the passenger transport installation.

In the same way, additional sensors, such as switches or button functions, e.g. emergency stop buttons or key-operated switches, and the influences thereof on the passenger transport installation can be simulated and checked.

The simulated status signals can be generated in the servicing controller or can be based on bus signals present at the local bus node and are reflected or responded to. If the installation controller can transmit test signals, for example, to the sensors and expects unchanged or modulated response signals, said response signals are, in the same way, supplied by the servicing controller.

In addition, the servicing controller may be designed to control the passenger transport installation during servicing work. In particular, the servicing personnel can send control signals to the drive motor by means of the servicing controller.

The servicing controller preferably comprises a user interface, via which the sensors to be replaced can be selected and the delivery of the simulated status signals can be controlled for selected states of the selected sensors.

The servicing provider can preferably replace and simulate safety-related sensors and non-safety-related, operation-related sensors. Sensors or switches that monitor the covering of a shaft or the access to a door of an elevator are safety-related. A sensor which monitors the illumination or air conditioning in an elevator cabin, for example, is not safety-related, i.e. the elevator installation is not switched off if the air conditioning fails. Furthermore, sensors may be provided which measure the acceleration of an elevator car, for example. Provided that no impermissible accelerations are to be expected, said acceleration sensors are not safety-related. The servicing controller can therefore also simulate non-safety-related processes and inspect the passenger transport installation with regard to additional functions.

The servicing controller is preferably suitable for delivering simulated status signals, by means of which the states or the status signals delivered by the sensors can be simulated, which status signals delivered by the sensors occur in a state or in a plurality of different states of the sensors or in the event of a plurality of different influences on the sensors.

EP2604564A1 discloses, for example, an elevator installation comprising a sensor which detects vibrations generated during operation of the elevator installation, and comprising an evaluation circuit, which evaluates vibrations detected by the sensor and compares said vibrations with a predefinable operating value and a predefinable threshold value. By means of the servicing controller, the behavior of the passenger transport installation or elevator installation can thus be examined upon occurrence of virtual vibrations.

In principle, all sensors of the passenger transport installation, such as electromechanical sensors, e.g. switches and relays, optical sensors or signal generators, magnetic sensors or signal generators, thermal sensors or signal generators or RFID modules, can be replaced and simulated by means of the servicing controller.

The selectable and replaceable sensors and the servicing controller are connected or can be connected to the associated bus nodes preferably by means of plug contacts. In this way, the relevant sensors can easily be replaced by the servicing controller by exchanging the plug contacts.

In a preferred embodiment, the servicing controller is switched between the sensors and the associated bus nodes, such that the status signals of the sensors or the simulated status signals of the servicing controller corresponding thereto can be selectively switched to the bus node.

Once the servicing controller has been connected to the bus system or status bus, the sensors to be replaced are selected, simulated status signals for the selected sensors are generated as required and are fed into the decentralized bus nodes, which correspond to the selected sensors.

The servicing controller is preferably designed in a modular manner and is provided with at least one contact module and at least one control module, which are interconnected in a wired or wireless manner. Once the contact module has been connected to the bus system or status bus, sensors to be replaced are selected by means of the control module, simulated status signals for the selected sensors are generated and are coupled into the decentralized bus nodes from the contact module, which bus nodes correspond to the selected sensors.

In a preferred embodiment, the servicing controller or the control module thereof transmits the simulated status signals and identification data for selected sensors to a centralized bus node, after which the decentralized bus nodes, which correspond to the selected sensors, are switched off. The servicing controller thus indicates to the installation controller of the passenger transport installation which sensors were selected, after which the installation controller identifies and switches off the associated bus nodes. A plurality of centralized bus nodes may be provided which are centralized with respect to the safety system, but which may be geographically decentralized. The servicing controller can therefore access the installation controller directly and replace an actual part of the safety system of the installation with a corresponding simulated part, the same status signals, i.e. actual status signals or simulated status signals, occurring at the interfaces of the actual and simulated part, which signals are practically identical.

The control module, preferably a tablet computer, can be carried by the servicing personnel during inspection of the passenger transport installation, and therefore the servicing personnel can intervene in the safety system and configure same at any desired location via the control module. By means of this configuration, actual parts of the safety system can selectively be replaced with simulated parts.

In a preferred embodiment, the servicing controller comprises a program module, by means of which the passenger transport installation is imaged together with the selectable sensors on a display unit, preferably a touchscreen of the control module. The sensors to be replaced can be selected by pressing a button, clicking the mouse or tapping the touchscreen.

In another preferred embodiment, the program module is suitable for imaging the passenger transport installation comprising the selectable sensors, including the interactions between the installation modules and the selectable sensors, on the display unit. In this way, the entire passenger transport installation can be virtually displayed and manipulated on the servicing controller.

The servicing controller is preferably provided with an authentication module which authenticates the user before intervention in the passenger transport installation and only permits use of the servicing controller after successful authentication. Preferably, biometric authentication procedures are used, such as those known from EP1962280A1. Before the servicing controller is used, the servicing technician establishes contact with a secure server and authenticates himself, after which the secure server transmits a security code, for example, to the servicing controller and/or the installation controller and enables said controller(s). In this way, it is ensured that only authorized personnel can have access to the installation controller.

Corresponding authentication is preferably also provided upon any other intervention into the installation controller of passenger transport installations.

### DESCRIPTION OF THE DRAWINGS

The passenger transport installation according to the invention is explained in greater detail below using examples and with reference to the drawings, in which:

FIG. 1 schematically shows an escalator serving as a passenger transport installation and comprising nine sensors and a control device, which control device comprises an installation controller that can selectively be connected via a status bus and local bus nodes to the assigned sensors or, as shown, to a servicing controller, by means of which the behavior of the sensors can be simulated;

FIG. 2 shows the passenger transport installation from FIG. 1 comprising a servicing controller, which servicing controller comprises a contact module that can be connected to the local bus nodes and a control module in the form of a tablet computer, by means of which the contact module can be controlled; and

FIG. 3 shows the passenger transport installation from FIG. 2 comprising a servicing controller that merely comprises the control module or the tablet computer, which can be connected to a central bus node.

### DETAILED DESCRIPTION

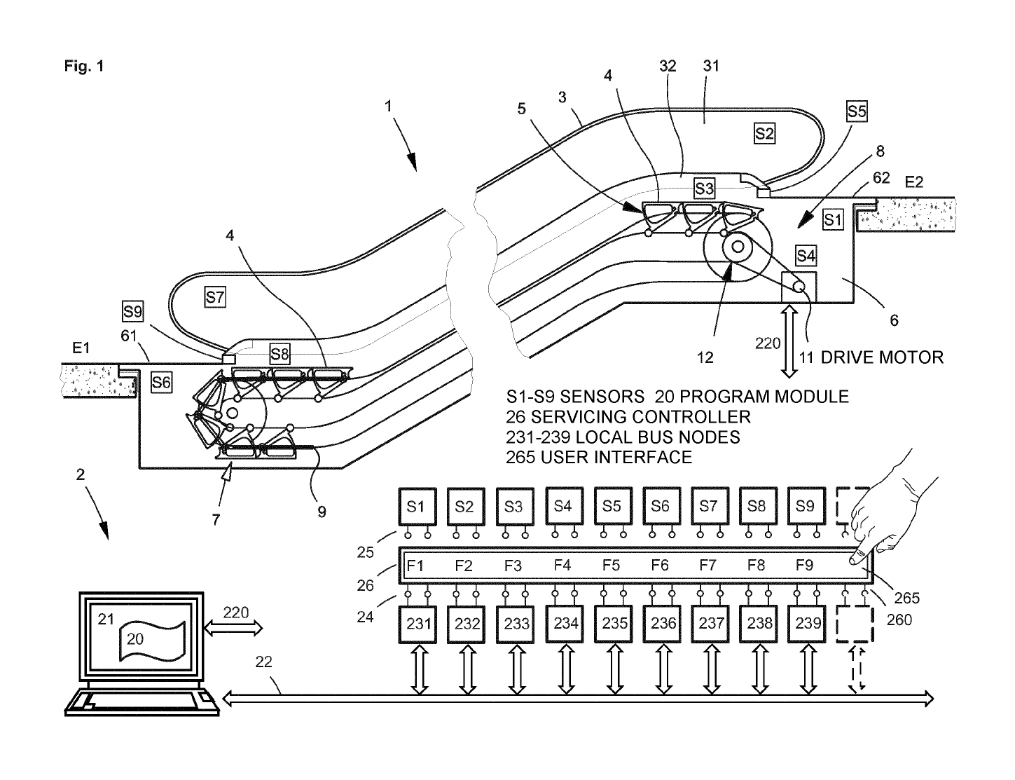

FIG. 1 is a schematic side view of an escalator 1 serving as a passenger transport installation that connects a first level E1 to a second level E2. The escalator 1 has a support structure 6 that is only illustrated by contour lines and comprises two deflection regions 7, 8, between which a step belt 5 is guided in a revolving manner. The step belt 5 comprises pulling means 9 on which steps 4 are arranged. A handrail 3 is arranged on a balustrade 31. The balustrade 31 is connected to the support structure 6 at the lower end by means of a balustrade base 32. The escalator 1 has a balustrade 31 on each of the two sides thereof, only one of which is visible in the side view.

The escalator 1 also comprises a drive motor 11, by means of which the step belt 5 and thus the conveying means, the handrail 3 and the steps 4 are driven via a reduction gear 12. The three-phase AC drive motor 11 is supplied with electrical energy from a power supply network.

FIG. 1 further shows that the passenger transport installation 1 comprises nine sensors S1, . . . , S9 integrated in the passenger transport installation 1 and a control device 2, which comprises an installation controller 21 which can be selectively connected via a status bus 22 and local bus nodes 231, . . . , 239 either to the assigned sensors S1, . . . , S9 or, as shown, to a servicing controller 26. By means of the servicing controller 26, the behavior of the sensors S1, . . . , S9 can selectively be simulated preferably for all states of the sensors S1, . . . , S9.

In normal operation, the local bus nodes 231, . . . , 239 receive status signals from the assigned sensors S1, . . . , S9 and transmit said signals via the status bus 22 to the installation controller 21. Subsequently, the installation controller 21 controls the passenger transport installation 1 in consideration of the received status signals. For this purpose, the installation controller 21 is provided with a program module 20 which processes the data transmitted via the status bus 22 and optionally also directs status queries to the sensors S1, . . . , S9 via the status bus 22. The dashed lines show that the passenger transport installation 1 may also comprise more or fewer bus nodes and sensors.

The passenger transport installation 1 is controlled via an installation bus 220, which controls simple or smart electrical modules inside the passenger transport installation 1, such as the drive motor 11.

FIG. 1 shows the geographical position of the sensors S1, . . . , S9 inside the passenger transport installation 1. The sensors S1 and S6 are designed as switches, for example, and monitor the position of cover plates 61, 62 at the access points of the installation. The sensors S2 and S7 are emergency stop buttons, for example. The sensors S3 and S8 monitor the steps 4 and are used, for example, to detect a missing or damaged step 4. The sensor S4 is a temperature sensor, for example, which monitors the temperature of the drive motor 11. The sensors S5 and S9 are proximity sensors, by means of which the approach of a passenger can be detected.

Below the image of the passenger transport installation 1, it can be seen that the bus nodes 231, . . . , 239 are separated from the sensors S1, . . . , S9 and instead can be connected to the servicing controller 26.

The bus nodes 231, ..., 239 are provided with plug contacts 24, the sensors S1, . . . , S9 are provided with plug contacts 25 and the servicing controller 26 is provided with plug contacts 260, which make it possible to selectively connect all or individual sensors S1, . . . , S9 or the servicing controller 26 to the free bus nodes 231, . . . , 239. The servicing controller 26 may be designed as a rigid or flexible printed circuit board, for example, which can selectively be connected to the bus nodes 231, . . . , 239.

In this preferred embodiment, the servicing controller 26 is additionally provided with a user interface 265, by means of which the sensors S1, . . . , S9 to be replaced and the states thereof are selectively chosen and the connected bus nodes 231, . . . , 239 can preferably be controlled individually. For this purpose, the servicing controller 26 generates simulated signals for each of the connected local bus nodes 231, . . . , 239, which signals correspond to the status signals of the replaced sensors S1, . . . , S9 in a selected state.

In order to program the servicing controller 26, the output signals or status signals of the sensors S1, . . . , S9, which occur in various states during operation of the passenger transport installation 1, are measured and stored. Therefore, preferably all possible states and characteristic curves of the sensors S1, . . . , S9 are stored in the servicing controller 26. Preferably, the installation controller 21 comprises a library in which sensor data are pre-stored. This makes it possible to configure the servicing controller individually. In the event of repair work, it can also be checked, for example, whether or not another sensor stored in the library is more suitable for use in the passenger transport installation 1. For example, the actual sensor S1 is initially replaced by a first imaginary sensor from the library and then by a second imaginary sensor from the library, and then the more suitable sensor is selected.

It is also possible for a sensor, e.g. a switch, to merely transmit signals via the status bus that were previously sent to said sensor by the installation controller. The servicing controller in this case provides for the behavior of the sensor to also be reproduced in the various states thereof. For example, a switch is provided which interconnects two bus lines if an event occurs.

After all sensor data have been recorded for the passenger transport installation 1 or the servicing controller 26 has been configured using data from the library, the sensors S1, . . . , S9 can be selected as desired and replaced by the servicing controller 26. In the embodiment in FIG. 1, all sensors S1, . . . , S9 have been replaced by the servicing controller 26.

The servicing controller 26 can now simulate all sensors S1, . . . , S9 and the different states thereof. For the sensor S4, which is assigned to the drive motor 11, the servicing controller can alter the status signal such that the installation controller 21 identifies overheating and switches off the drive motor 11. By activating the simulated sensors S5 and S9, the approach of a passenger to the person transport installation 1 can be simulated, after which it is checked whether the installation is set in motion according to requirements. By correspondingly activating the sensors S3 and S8, a missing or damaged step 4 can be simulated, and the reaction of the installation controller 21 can be examined. By actuating the sensors S2 and S7, emergency stops can be signaled. By actuating the sensors S1 and S6, which are designed as simple switches, for example, it can be signaled that the covers 61, 62 are correctly in position above the support structure 6 even though they have been removed. By means of the servicing controller 26, the servicing technician can therefore simulate the covers 61, 62 being closed and remove said covers in order to gain access into the support structure 6 without the passenger transport installation 1 being switched off.

In the same way, an elevator installation comprising a servicing controller 26 according to the invention can be provided. For example, the sensors S1 and S6 are assigned to the elevator doors. The servicing technician can in turn simulate the closed state of the elevator doors and open said doors in order to gain access into the elevator shaft. By means of the sensor S4, elevated temperatures of the motors of the elevator installation can be signaled in order to examine the behavior of the installation. The servicing controller 26 according to the invention is therefore universally applicable.

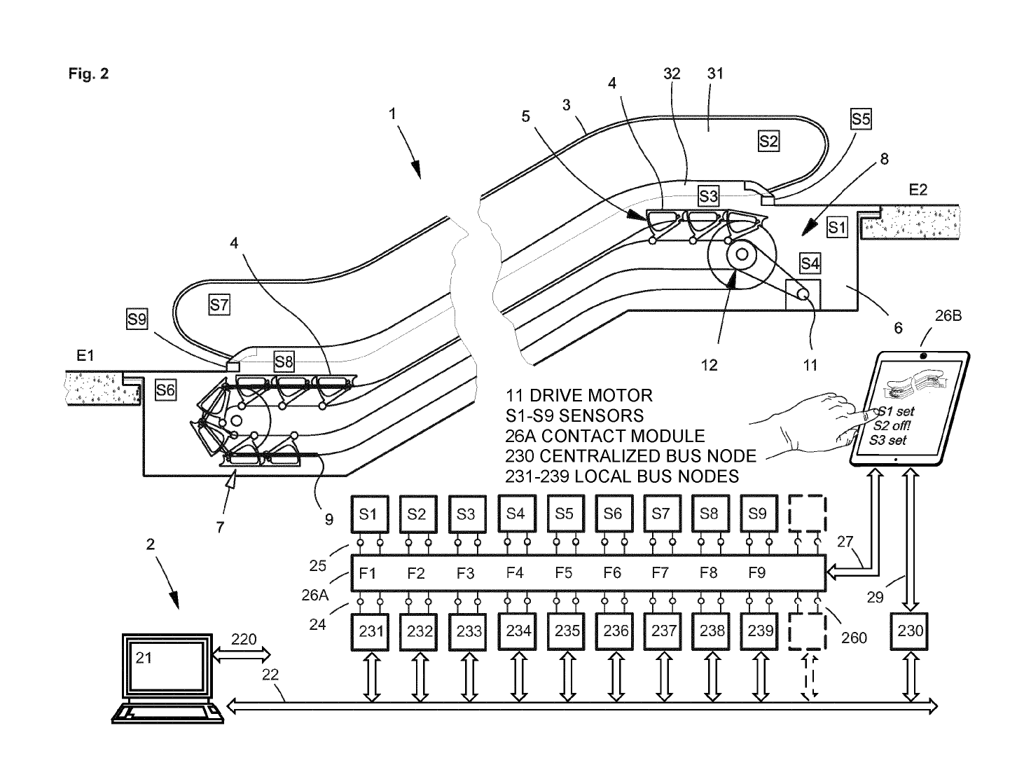

FIG. 2 shows the passenger transport installation 1 from FIG. 1 comprising a modular servicing controller 26A, 26B, which comprises a contact module 26A that can be connected to the local bus nodes 231, . . . , 239 and a control module 26B in the form of a tablet computer, by means of which the contact module 26A can be controlled.

The contact module 26A and the control module 26B are interconnected by means of a wired or wireless transmission channel 27. Preferably, a wireless connection is provided, such that the servicing technician can carry the tablet computer 26B with him and configure the safety system of the control device 2 in any position, as required. The tablet computer 26B preferably has a touchscreen, which serves as the user interface and via which the servicing technician can selectively adjust the states of the selected or replaced sensors S1, . . . , S9.

The servicing controller 26A, 26B or control module 26B preferably comprises a program module, by means of which the passenger transport installation 1 can be imaged together with the selectable sensors S1, . . . , S9 on the display unit or touchscreen. As shown in FIG. 2, the passenger transport installation 1 can be imaged on the touchscreen, such that the sensors S1, . . . , S9 can be selected at the respective positions in the installation. Alternatively, a list may be displayed in which the sensors S1, . . . , S9 are tabulated.

Preferably, the passenger transport installation 1 comprising the selectable sensors S1, . . . , S9 and the interactions of the installation modules are imaged on the touchscreen. The servicing technician can therefore compare the behavior of the imaged passenger transport installation 1 with the actual behavior of the passenger transport facility 1 and identify and investigate discrepancies.

FIG. 2 further shows that the servicing controller 26 or the contact module 26A can be connected to the bus nodes 231, . . . , 239 and to the sensors S1, . . . , S9. In this preferred embodiment, the servicing controller 26 can selectively connect the sensors S1, . . . , S9 to the bus nodes 231, . . . , 239 and separate said sensors from said bus nodes and simulate the replaced sensors S1, . . . , S9. Alternatively, the actual status signals of the sensors S1, . . . , S9 or the simulated status signals of the functional controller 26 can therefore be delivered to the bus nodes 231, . . . , 239. In this way, the sensors S1, . . . , S9 can additionally be checked.

Since unauthorized interventions in the control device 2 of the passenger transport installation 1 lead to security risks, preferably, the user of the servicing controller 26 or control module 26B must be authenticated. For this purpose, a list of authorized servicing technicians is preferably provided in the control module 26B or in a centralized secure server. The control module 26B and, preferably in parallel therewith, the installation controller 21 are enabled for intervention by means of the authentication of the servicing technician. The authentication can be carried out for example by means of a password or biometric data, such as fingerprint recognition, face recognition, speech recognition, etc.

FIG. 2 shows that the control module 26B is additionally connected to the installation controller 21 via a wired or wireless communication channel 29 and a centralized bus node 230 and can preferably intervene in said installation controller.

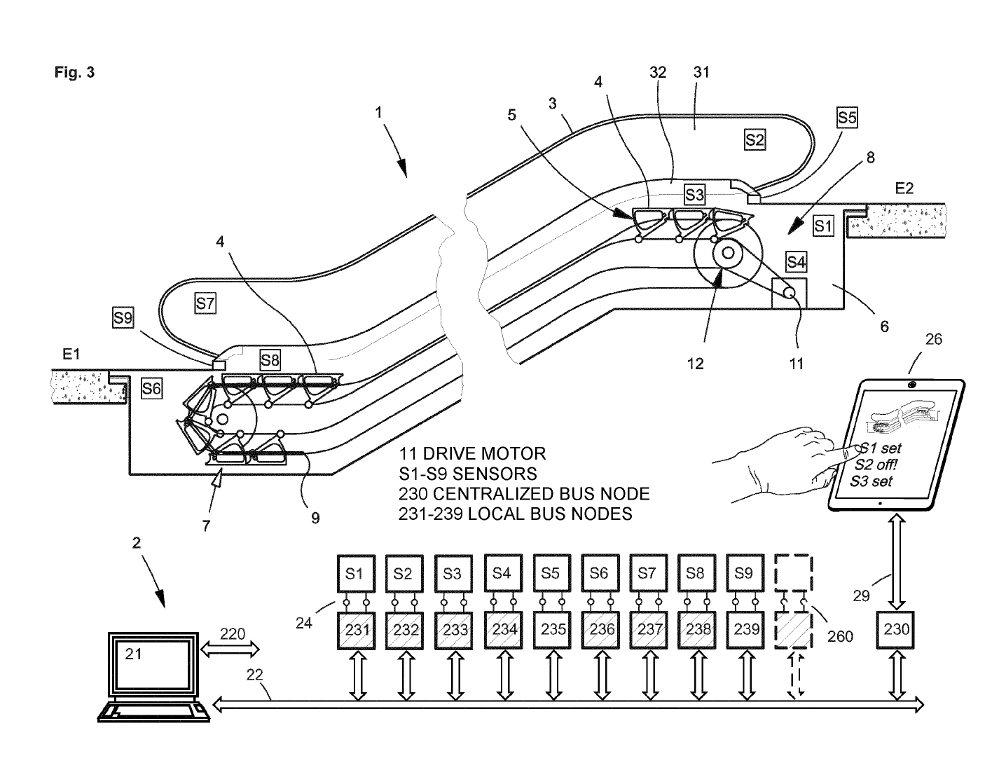

FIG. 3 shows the passenger transport installation 1 from FIG. 2 comprising a servicing controller 26 that merely comprises the control module 26B or tablet computer 26, which is connected to the central bus node 230. The installation controller 21 is informed of which sensors S1, S2, S3, S4, S6, S7, S8 are simulated by means of the servicing controller 26 via said bus node 230. The installation controller 21 subsequently blocks communication with the bus nodes 231, 232, 233, 234, 236, 237, 238 (shown with hatching) corresponding to said sensors and takes command from the servicing controller 26 of the simulated signals for the replaced sensors S1, S2, S3, S4, S6, S7, S8. For example, the states of the replaced sensors S1, S2, S3, S4, S6, S7, S8 are sequentially queried or transmitted. Furthermore, with every selection of a sensor S1, S2, S3, S4, S6, S7, S8 to be replaced or with every change in state of a replaced sensor S1, S2, S3, S4, S6, S7, S8, the servicing controller 26 can send a data frame or a telegram to the servicing controller 21 and notify of the configuration change.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16 (canceled)

17. A passenger transport installation including at least one drive motor, a conveying means, at least one sensor and an installation controller, the installation controller being connected to at least one local bus node via a status bus, the at least one local bus node receiving status signals from the at least one sensor and transmitting the status signals to the installation controller via the status bus, the installation controller controlling the passenger transport installation in response to the status signals received from the at least one local bus node, comprising:
a servicing controller that, as a replacement for the at least one sensor, is connected to the at least one local bus node or to a centralized bus node connected to the status bus, and wherein the servicing controller delivers simulated status signals that correspond to the status signals from the replaced at least one sensor in a state that is selected by the servicing controller.

18. The passenger transport installation according to claim 17 wherein the simulated status signals are generated in the servicing controller or are generated based on bus signals that are present at the at least one local bus node.

19. The passenger transport installation according to claim 17 wherein the servicing controller includes a user interface for at least one of controlling the delivery of the simulated signals and selecting the at least one sensor to be replaced.

20. The passenger transport installation according to claim 17 wherein the servicing controller is adapted for replacing safety-related sensors or for replacing non-safety-related, operation-related sensors of the passenger transport installation.

21. The passenger transport installation according to claim 17 wherein the servicing controller delivers the simulated status signals that correspond to the status signals from the at least one sensor thereby simulating states of the at least one sensor or the status signals from the at least one sensor, wherein the status signals delivered by the at least one sensor occur in a state or in a plurality of different states of the at least one sensor or in an event of various influences on the at least one sensor.

22. The passenger transport installation according to claim 17 wherein the at least one sensor is one of an electromechanical sensor, an optical sensor or signal generator, a magnetic sensor or signal generator, a thermal sensor and an RFID module.

23. The passenger transport installation according to claim 17 wherein the servicing controller is adapted to:
select sensors, including the at least one sensor, of the passenger transport installation to be replaced;
generate simulated status signals for the selected sensors; and
couple the simulated status signals into local bus nodes that correspond to the selected sensors, or couple the simulated status signals and identification data for the selected sensors into a centralized bus node, and switch off the local bus nodes that correspond to the selected sensors after the coupling.

24. The passenger transport installation according to claim 17 wherein the servicing controller includes a contact module and a control module, and wherein:
the control module is adapted for selecting sensors of the passenger transport installation, including the at least one sensor, to be replaced, for generating simulated status signals for the selected sensors, and for delivering the simulated status signals to the contact module; and
the contact module is adapted for coupling the simulated status signals into local bus nodes that correspond to the selected sensors.

25. The passenger transport installation according to claims 17 wherein the servicing controller includes a program module by which the passenger transport installation is imaged together with selectable sensors of the passenger transport installation on a display unit, or by which the passenger transport installation is imaged together with the selectable sensors, including interactions of a contact module and a control module of the servicing controller and the selectable sensors, on the display unit.

26. The passenger transport installation according to claim 17 wherein the servicing controller includes a contact module and a control module, the control module being a tablet computer connected to the contact module by a wired or a wireless communication channel.

27. The passenger transport installation according to claim 17 including a plurality of selectable sensors and associated local bus nodes and wherein the servicing controller is connected to the associated bus nodes by plug contacts.

28. A method for servicing the passenger transport installation according to claim 17, comprising the steps of:
connecting the servicing controller to the at least one local bus node or to the centralized bus node; and
operating the servicing controller to deliver the simulated status signals which correspond to the status signals of the at least one sensor in a selected state.

29. The method according to claim 28 including operating the servicing controller to perform the steps of:
selecting sensors of the passenger transport installation, including the at least one sensor, to be replaced;
generating simulated status signals for the selected sensors; and
coupling the simulated status signals into local bus nodes that correspond to the selected sensors, or coupling the simulated status signals and identification data for the selected sensors into the centralized bus node, and after the coupling, switching off the decentralized bus nodes that correspond to the selected sensors.

30. The method according to claim 29 wherein the servicing controller includes a contact module and a control module, and including the steps of:
interconnecting the contact module and the control module with a wired or a wireless communication channel;
selecting the sensors to be replaced using the control module;
generating the simulated status signals for the selected sensors using the control module;
delivering the simulated status signals to the contact module; and
coupling the simulated status signals into the local bus nodes corresponding to the selected sensors using the contact module.

31. The method according to claim 29 wherein the servicing controller includes a program module, and including using the program to image the passenger transport installation together with the sensors on a display unit, or using the program module to image the passenger transport installation together with the sensors, including interactions of the modules and the sensors, on the display unit.

32. A servicing controller for a passenger transport installation, the passenger transport installation including a drive motor, a conveying means, a plurality of sensors and an installation controller, the installation controller being connected to a plurality of local bus nodes via a status bus, each of the local bus nodes receiving status signals from an associated one of the sensors and transmitting the status signals to the installation controller via the status bus, the installation controller controlling the passenger transport installation in response to the status signals received from the local bus nodes, comprising: the servicing controller being connected to the local bus nodes or to a centralized bus node connected to the status bus, and wherein the servicing controller is adapted to select each of the sensors for replacement and deliver simulated status signals that correspond to the status signals from the replaced sensors in a state that is selected by the servicing controller.
